(19) United States
(12) Patent Application Publication
(10) Pub. No.: US 2023/0393390 A1
(43) Pub. Date: Dec. 7, 2023

(54) LAMINATE WITH LARGE AREA HUD AND SOLAR PROPERTIES

(71) Applicant: AGP America S.A., Ciudad de Panama (PA)

(72) Inventors: Mario Arturo MANNHEIM ASTETE, Lima (PE); Sebastian M. GOMEZ SOCOLA, Lima (PE); Helene A. GRIOT, Lima (PE); Juan Pablo SUÁREZ, Aechen (DE); José NUÑEZ-REGUEIRO, Novi, MI (US); Pooria HOSSEINI, Baesweiler (DE); Zhaoyu WANG, Novi, MI (US); Alexey KRASNOV, Canton, MI (US)

(21) Appl. No.: 18/040,639

(22) PCT Filed: Aug. 5, 2021
(86) PCT No.: PCT/IB2021/057218

§ 371 Date: Feb. 3, 2023

Related U.S. Application Data
(60) Provisional application No. 63/061,355, filed on Aug. 5, 2020.

(51) Int. Cl. G02B 27/01; G02B 27/18; G02B 17/08; G02B 1/116; B60K 35/00

(52) U.S. Cl. CPC G02B 27/0101; G02B 27/18; G02B 17/0856; G02B 1/116; B60K 35/00; G02B 2027/0196; B60K 2370/334; B60K 2370/785

(57) ABSTRACT

The invention provides for a coating which when used in conjunction with a p-polarization projector (26) and a windshield mounted such that the angle between projector is at or near the Brewster angle, a sharp image is produced with no ghost image. Further, the coating is suitable for use over the entire area of the windshield, has excellent solar control properties and has a low sheet resistance allowing it to be electrically defrosted at common automotive voltages.

### BACKGROUND OF THE INVENTION

Head-Up Display (HUD), is a technology which displays information in a manner that allows a vehicle operator to monitor the values of variables normally displayed in the instrument panel without having to look down. In other words, with his head up. The operator can continue to view the environment in the forward direction of travel without having to look down at the instrument panel to check speed, RPM and other values. The projected graphic appears as if floating in space in front of the vehicle.

The principle of operation is simple. If you have ever placed a map or other light-colored object on the instrument panel of your car, you may have noticed that the reflection made it appear as if the object was floating in front of the windshield. In the same manner a projector is placed in the instrument panel which projects the graphic onto the windshield. The image is reflected by the windshield which serves to combine the projected image with the forward view of the driver.

Originally developed for use by aircraft pilots, the first HUD displays began to appear in automobiles in the 1980s. Due to the high price and limited perceived utility, growth was slow. However, as efforts to reduce driver distraction from the overload of information available to the driver have increased, so has the value of HUD. Further the much smaller size and lower weight of the once bulky graphic projectors has dramatically improved the feasibility of deployment in more and more vehicles. The technology used to produce the projector is the same as used for mobile phone, tablet laptop and television displays which has reduced the cost of the projectors.

For the 2020 model years, in the USA alone, over 300 vehicle models were available with HUD as standard equipment or an option.

The production of windshields that are optimized for HUD brings with it a number of challenges.

The best possible image, when projecting an image onto a surface, occurs when the projected image is perpendicular to a flat surface. As a windshield is typically curved and the projector cannot be mounted such that the beam is projected perpendicular to the windshield, the projected image must be compensated so that it is undistorted when viewed.

In a HUD system, the windshield becomes a critical component in the optical path and as such must be manufactured with a minimal amount of variation in curvature to prevent distortion. The level of precision required often exceeds traditional windshield manufacturing capability. As a result, manufacturers must upgrade to more advanced processes and/or inspect a larger percent of production.

Another challenge presented by the typical windshield is that of multiple images.

In FIG. 2A we see a cross section of a standard windshield. We have an inner glass layer 202, an outer glass layer 201 and a plastic bonding interlayer 4 which serves to permanently bond the two glass layers together. The HUD projector 24, mounted in the instrument panel, projects an image onto surface four 104 of the inner glass layer 202 of the windshield. The light enters the windshield at point one 51. At point one, some of the light is reflected due to the discontinuity of the index of refraction between the air and the glass. This reflected beam 31 is perceived by the viewer 40 as the primary image. The transmitted portion, not reflected, of the beam is bent as it enters the glass. The beam passes through the inner glass 202, the interlayer 4 and strikes the number one surface 101 of the outer glass layer 201 at point two 52. Once again, the air glass interface causes some of the light to be reflected back. From point two 52, the light travels back through the laminate and exits the glass stack at point three 53 where the reflected beam 32 is perceived by the viewer as a secondary image (also known as ghost image). The secondary image formed by the reflected beam 32 will be dimmer than the primary image formed by the reflected beam 31 but under the right cabin and exterior lighting conditions may still be visible. The separation distance between the two images will also have an effect on how noticeable the ghost image may be. If the distance is small and the two images overlap, the secondary will tend to enhance and improve the brightness of the primary image. If the separation distance is too great, the perception will be of a ghost image which is undesirable.

The plastic interlayer used to laminate all safety glass windshields has its refractive index matched to the index of refraction of the glass to prevent internal reflections. However, if the windshield is provided with a coating on the number two 102 or number three 103 surface internal reflections will result unless the coating is also matched to the index of refraction of the glass and interlayer (which is about 1.5). This is typically not the case with the transparent metallic/dielectric solar control coatings 18 depicted in FIG. 2B that are finding more and more use as manufacturers seek to increase the fuel efficiency of their vehicles while also improving passenger comfort and convenience. These coatings are tuned to transmit in the visible light range while reflecting in the infrared range.

As they are electrically conductive, they can also be used to provide resistive heating of the windshield. The sheet resistance of these coatings ranges from a low sheet resistance of ˜0.8 ohms per square to ˜5 ohms per square depending upon the number of layers, types of material and thickness of the layers. At this range of resistance, the typical windshield will have too high of a resistance to develop sufficient power to defrost. A power density of no less than four watts per square decimeter is generally needed to keep a typical windshield clear of condensation and ice. A voltage higher than that of the standard 12-volt automotive electrical system must be used to reach this power level unless the windshield is very short allowing the bus bar separation distance to be relatively small. Very few vehicles have been produced that meet this criterion.

The added cost and weight of the equipment needed to provide this higher voltage has limited the growth of coated heated windshields which remain uncommon.

However, resistive heating of a windshield is about four times as effective as hot air blower systems in clearing the laminate of moisture, ice, and snow, so this option is expected to grow. The lower power required for defrosting on an all-electric or hybrid vehicle translates directly into greater range.

Solar coatings present additional problems when used in a HUD windshield as illustrated in FIG. 2B which illustrates a typical solar coating windshield with a silver-based coating 18 on surface three 103. The beam path of FIG. 2A remains the same. But, at the coating-interlayer interface an additional reflection can be found at point four 54. The light exits the inner glass surface 104 at point five 55 and results in a third or tertiary image formed by the reflected beam 33 in addition to the secondary image formed by the reflected beam 32.

As ghost images are only a problem when the separation distance is too great, it has been found that making a small adjustment between the planes of the two glass layers can shift the images so that they converge. Normally the two glass layers are substantially parallel. To create an angle between them a plastic interlayer that is non-uniform in thickness is used. This is known as a “wedge” interlayer.

There are a number of methods used to produce wedge interlayer. With some the taper in thickness is at a constant angle across the whole width of the interlayer. Other methods maintain a constant thickness and then begin to taper as they approach the HUD portion of the interlayer. Still other methods have been devised that make use of a variable angle tailored to the specific windshield. A laminate with a wedge interlayer is illustrated in FIG. 3A.

In addition to the wedge interlayer, the use of very thin glass has been used to reduce the separation distance as well as tapered thickness glass. A drawback that of all of the wedge solutions share is that they are only effective for a secondary image. If there are more than two reflected images, then the wedge solution can only be optimized for one of the secondary reflected images. Also, the wedge solution can only be optimized for a portion of the driver field of view due to the curvature of the windshield and varying incident angle.

While wedge interlayer is effective and in common use, it does have drawbacks.

For one, it is much more expensive to produce than standard interlayer. The angle is produced through an extrusion process. This requires a change in the tooling and a transition period during which the product is not within tolerances.

Due to the several different angles, different sunshade tint color and width, roll widths and other dimensions needed, the wedge interlayer is generally produced upon request for a specific model windshield in relatively short production runs and not kept in inventory. As a result, it can have a long lead-time.

The non-uniform thickness can result in problems passing regulatory requirements as it can get too thin or too thick, especially on larger parts. This is why there are some variants that maintain constant thickness and do not start the taper from the top of the interlayer sheet.

The biggest drawback of wedge interlayer is that the image displacement is only corrected in the vertical direction and only at the center of the field of view. This is not so much an issue with the current relatively small displays intended primarily for the driver and centered with the drivers' field of view but as the display area increases, and at some point, may encompass the entire windshield, a single wedge will not be an option.

Another approach to correct for ghost image and improve the quality of the graphic image is through the use of a HUD film 22. This approach is illustrated in FIG. 3B. Here, as in the coated glass example, the beam follows the same path as shown in FIG. 2A and results in a ghost image formed by the reflected beams 31 and 32. However, as the HUD film 22 is laminated between two layers of a plastic bonding layer such as PVB interlayer, the reflected beam 32 exiting the 104 surface at point three 53 is closer to the reflected beam 31 exiting at point one 51, which makes the primary and secondary images form closer together. The higher reflectivity of the HUD film 22 reduces the intensity of the light transmitted past point two 52 and effectively eliminates the tertiary image that would have resulted from the reflection from the number one 101 surface. The reflection is still there but the intensity is much lower which makes it unnoticeable. These HUD films may be laminated between two layers of plastic bonding layer 4 or optically bonded to the number two 102 or number three 103 surface. A HUD film may be used along with a wedge interlayer to further improve optics.

Holographic film HUD projectors have also been developed in the last few years. They have not been widely implemented due to a number of drawbacks. They require an expensive projection system (narrowband laser diodes) and a special holographic film interlayer.

The HUD holographic films have similar drawbacks to the wedge PVB solution. They are expensive and in addition to the higher material cost of the film and the second layer of interlayer or optical adhesive, there is also additional labor required to assemble the laminate with the film inside. The integration of the film into the WS has problems such as wrinkles in the film, performance degradation due to chemical reaction with the interlayer) and diffraction of sunlight. The edges of the film tend to be visible as well. The only means found to overcome this limitation has been to extend the film across the entire windshield. This of course increases the cost even further and makes lamination that much more difficult.

As the quantity of information and the corresponding size of the HUD viewing area increases, films become less and less viable. Due to their optical and mechanical properties the size of the area where the film can be used is limited. They are not suitable for use in the drivers' direct line of sight due to their optical properties. It may not be possible to laminate some films in windshields with complex curvature due to the inability of the film to conform to the curvature.

Another approach makes use of the optical properties of light. Light is comprised of perpendicular coupled oscillating electric and magnetic fields. Polarization describes the relative orientation of the fields to a reference. Sunlight is thought of as having random polarization. In fact, it is comprised of an equal mix of various polarizations. This is considered as unpolarized light.

The incident angle is the angle between the propagation direction and the normal of the surface. The polarization of light is inherent and independent of the incident angle. If the optical field is oscillating in a plane parallel to the propagation plane, then the light is P-polarized. If the field oscillates in a plane perpendicular to the propagation plane, then it is S-polarized.

An interesting phenomenon that we can take advantage of is the fact that p-polarized light is not reflected when the angle of incidence is at or near the Brewster angle. The Brewster's angle is an angle of incidence at which light with a particular polarization is perfectly transmitted through a transparent dielectric surface, with no reflection. In this case, for an interface between the soda-lime glass and air, the Brewster angle where reflection for p-polarized light is zero, is 60° approximately. Over the range from 55° to 65° the reflection is negligible. In FIG. 6 reflection as a function of incidence angle is shown for both s and p polarization.

In the discussions so far, the HUD projectors used project mainly s-polarized light. Beside the secondary image, another problem with s-polarized systems is that polarized sunglasses only allow p-polarized light to transmit. Therefore, the HUD image would not be highly visible to a driver with such eyewear.

If we have a HUD projector that emits primarily p-polarization light 26 and mount the projector such that the beam projected is at the Brewster angle when entering the glazing, the reflections at the air interfaces are mostly eliminated. This situation is illustrated in FIG. 4A. The projector 26 projects an image formed by the incident beam using p-polarized light. But there is no reflection at point one 51 or point two 52. As a result, no image is produced.

In a windshield with a p-polarized projector and a HUD film designed to reflect p-polarized light 26, there will only be a single primary image rather than a sum of multiple reflected images. Looking at FIG. 4B, with the HUD film 22 and projector 26, the reflection at point one 51 is eliminated. The reflection at point two 52 from the HUD film 22 exits the glass at point three 53 and becomes the primary image formed by the reflected beam 31.

This solution solves the problem of ghost image; however, it of course has the same drawbacks as described for other types of HUD films. Further, the HUD films known in the industry are all layered plastic with no solar or heating properties. They are expensive and not suitable for use over a larger field of view due to their difficulty in forming to the curvature of the glazing.

As the field of view becomes larger and HUD displays become more common it would be highly desirable to be able to eliminate multiple images while also improving the quality of the image, without the use of a wedge interlayer or HUD film, to have solar control and the capability of electrical heating all in one single product.

### Brief Summary of the Invention

The invention is an automotive HUD system comprising a coated laminate and a HUD projector.

The HUD projector is mounted such that the image is projected at or near the Brewster angle and the light source is substantially p-pol polarized.

The laminate comprises at least two glass layers, at least one plastic interlayer and a coating applied to at least one of the internal glass surfaces. The coating comprises a complex, multi-layer stack. The coating is designed and tuned to have a p-polarized reflectivity to total reflectivity ratio that in each of the spectral ranges of 450-510 nm, 510-590 nm and 590-670 nm, takes on a local extreme in each. An extreme is a local minimum or a local maximum. Further, two of the ranges will have a maximum and the third a minimum or two will have a minima and the third a maximum and the difference in p-polarized reflectivity to total reflectivity ratio between the opposite extrema is at least 0.3. This allows use to selectively emphasize or deemphasize a range of colors.

The coating utilizes conductive and dielectric layers to achieve a sheet resistance of under 1 ohm per square. Solar control properties are close to the theoretical limit with nearly all infrared light being reflected while visible light transmission is held at greater than 70% making it suitable for automotive windshields as well as roofs and sidelites. The coating transmitted color is neutral. The coating is durable, heat and scratch resistant.

The laminate when used in conjunction with a p-polarized HUD projector mounted at or near the Brewster angle, yields a bright and sharp image, free of ghost image from any viewing angle. The image can be projected potentially over the entire area of the windshield. With four silver containing layers having a minimum thickness of 100Å and a sheet resistance of less than 1 ohm per square, the coating has the potential to be used as a heating element to provide defrosting with a standard 12 V nominal automotive electrical system.

### Advantages

Ghost image eliminated
Less sensitive to viewing angle
Suitable for the entire laminate
Excellent solar properties
High electrical conductivity
Most laminates can be defrosted with just 12 volts.
Eliminates wedge interlayer
Eliminates HUD film
Lower cost compared to using wedge or HUD film
Neutral color in transmission and reflection.
Image can be viewed with polarized eyewear

### Brief Description of the Several Views of the Drawings

FIG. 1A illustrates the cross section of a typical laminated automotive glazing.

FIG. 1B shows the cross section of a typical laminated automotive glazing with performance film and coating.

FIG. 1C shows the cross section of a typical tempered monolithic automotive glazing.

FIG. 2A shows the cross section of a standard windshield with HUD.

FIG. 2B shows the cross section of a typical solar coated windshield with HUD.

FIG. 3A illustrates the cross section of a HUD windshield configured with a wedge interlayer.

FIG. 3B shows the cross section of a HUD windshield configured with HUD film.

FIG. 4A shows the cross section of a HUD windshield configured with a p-polarization projector.

FIG. 4B shows the cross section of a HUD windshield configured with a p-polarization projector and a HUD film.

FIG. 5 shows the cross section of a HUD windshield configured with a p-polarization projector and a HUD coating according to a preferred embodiment of this invention.

FIG. 6 shows a graph of the simulated reflection of the laminated glazing of FIG. 5 as function of the angle of incidence for a medium with refractive index equal to 1.5. The Brewster angle, where the reflection for p-polarized light is 0, in this case is 60°.

FIG. 7A shows a graph of the simulated ratio of p-polarized reflection to total reflectivity at the incident angle of 60° from four, four-silver containing layer coating applied to a laminated glazing such as the one depicted in FIG. 5.

FIG. 7B show and exemplary four-silver containing layer coating stack of the invention.

FIG. 7C shows some of the typical materials used and their function in the coating stack of this invention.

### Reference Numerals of Drawings

2 Glass
4 Bonding/Adhesive layer (plastic Interlayer)
6 Obscuration/Black Paint
12 Infrared reflecting film
18 Infrared reflecting coating
22 HUD Film
24 HUD Projector
26 HUD Projector p-polarization
28 HUD Conductive Solar Coating
30 Projected Image
31 Primary Image
32 Secondary Image
33 Tertiary Image
40 Eye point
51 Point 1
52 Point 2
53 Point 3
54 Point 4
55 Point 5
56 Point 6
61 Local extreme 1
62 Local extreme 2
63 Local extreme 3
101 Exterior side of glass layer 1 (201), number one surface.
102 Interior side of glass layer 1 (201), number two surface.
103 Exterior side of glass layer 2 (202), number 3 surface.
104 Interior side of glass layer 2 (202), number 4 surface.
201 Outer glass layer
202 Inner glass layer

### Detailed Description of the Invention

The following terminology is used to describe the laminated glazing of the invention.

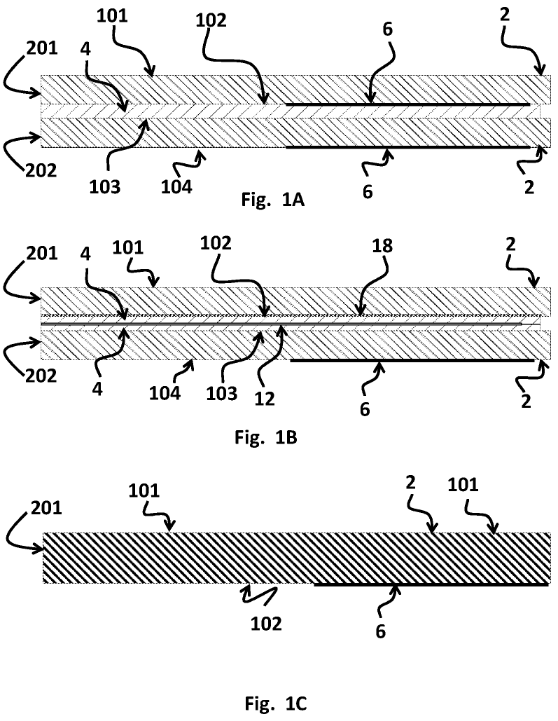

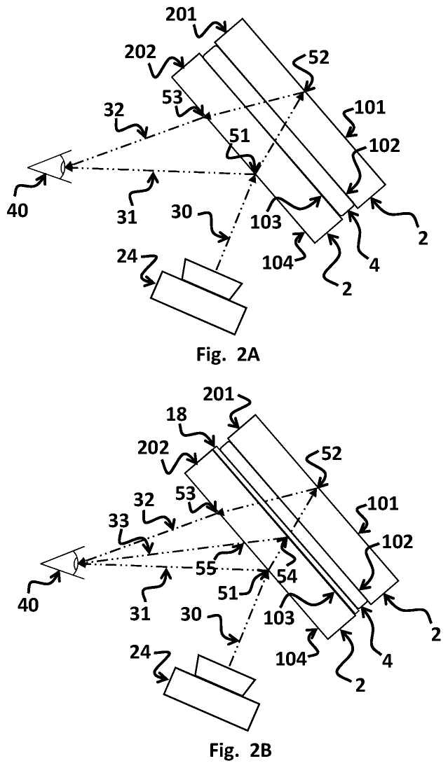

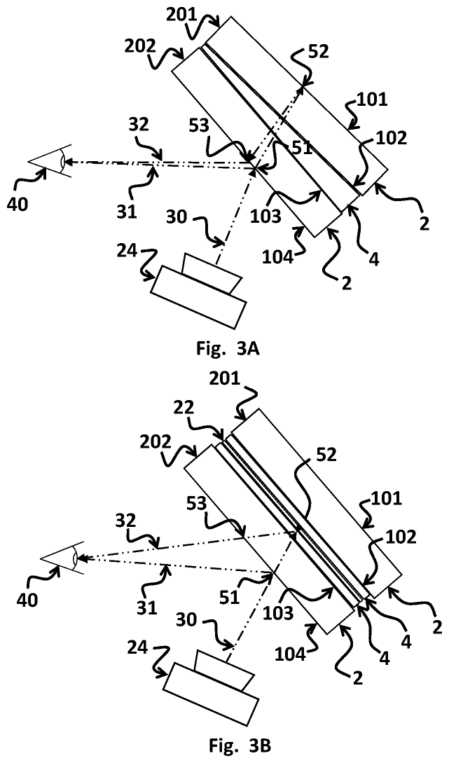

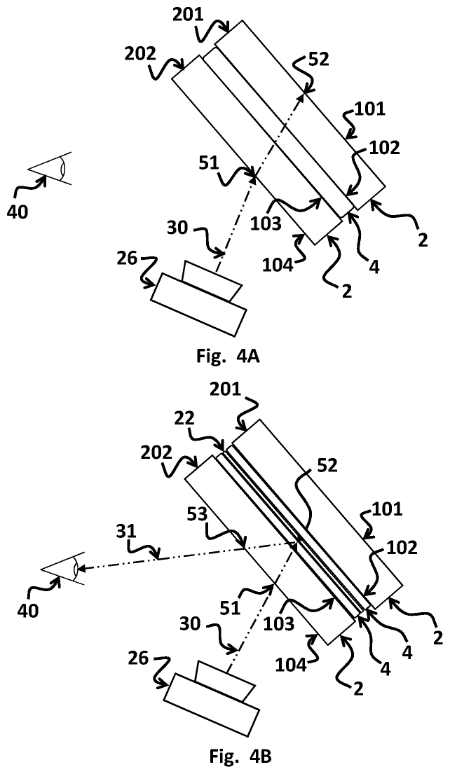

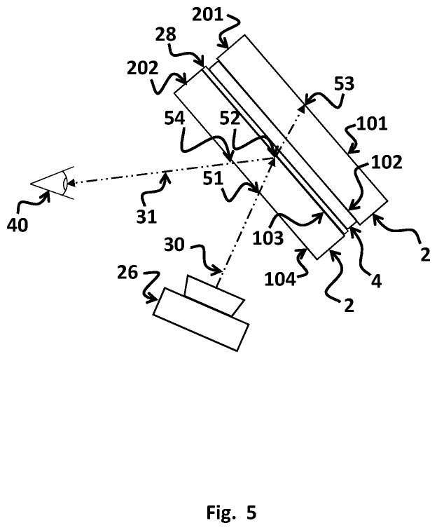

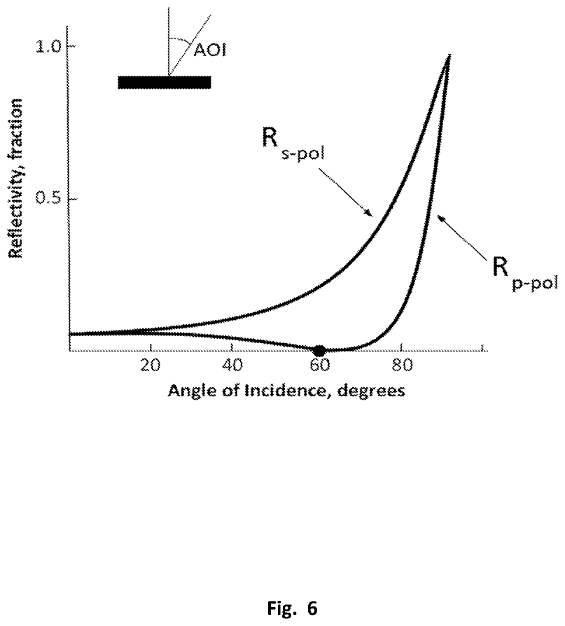

Typical automotive laminated glazing cross sections are illustrated in FIGS. 1A and 1B. A laminate is comprised of two layers of glass, the exterior or outer, 201 and interior or inner, 202 that are permanently bonded together by a plastic bonding layer 4 (interlayer). In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding layer 4. An obscuration 6 may be also applied to the glass. Obscurations are commonly comprised of black enamel frit printed on either the number two 102 or number four surface 104 or on both. The area of the glazing that is not covered by an obscuration is the daylight opening. The laminate may have a coating 18 on one or more of the surfaces. The laminate may also comprise a film 12 laminated between at least two plastic bonding layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the number one 101 and/or number two 102 surfaces.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding two sheets (201 & 202) of annealed glass 2 together using a plastic bonding layer comprised of a thin sheet of transparent thermo plastic 4 (interlayer) also known as plastic bonding layer as shown in FIG. 1A and 1B.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic bonding layer 4 also helps to prevent penetration by objects striking the laminate from the exterior and in the event of a crash occupant retention is improved.

Full surface windshield heating is commonly provided through the use of a conductive transparent coating which is used to form a heating element. The coating is vacuum sputtered directly onto the glass and is comprised of multiple layers of metal and dielectrics. With resistances in the range of 2-6 ohms per square, a voltage convertor is needed to reach the power density required. Busbars are comprised of printed silver frit, applied, and fired prior to coating or are comprised of thin flat copper conductors.

For very thin conductive materials we typically characterize the resistance in terms of the sheet resistance. The sheet resistance is the resistance that a rectangle, with perfect busbars on two opposite sides, would have. Sheet resistance is specified in ohms per square. This is a dimensionally unitless quantity as it is not dependent upon the size of the square. The busbar-to-busbar resistance remains the same.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass including those that are not transparent. The glass layers may be comprised of heat absorbing glass compositions as well as infrared reflecting and other types of coatings.

A wide range of coatings, used to enhance the performance and properties of glass, are available and in common use. These include but are not limited to anti-reflective, hydrophobic, hydrophilic, self-healing, self-cleaning, anti-bacterial, anti-scratch, anti-graffiti, anti-fingerprint, and anti-glare.

The coating of the invention is applied by means of an MSVD coater to the flat glass prior to bending.

The plastic bonding layer 4 (interlayer) has the primary function of bonding the major faces of adjacent layers to each other. The material selected is typically a clear thermoset plastic.

For automotive use, the most commonly used plastic bonding layer 4 (interlayer) is polyvinyl butyl (PVB). PVB has excellent adhesion to glass and is optically clear once laminated. It is produced by the reaction between polyvinyl alcohol and n-butyraldehyde. PVB is clear and has high adhesion to glass. However, PVB by itself, is too brittle. Plasticizers must be added to make the material flexible and to give it the ability to dissipate energy over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

Infrared reflecting coatings also known as solar control coatings 18 include but are not limited to the various metal/dielectric layered coatings.

One of the issues with MSVD solar coatings is color. The coatings can have an objectionable color in reflection and transmission. As coater technology has improved so has the capability to tune the color in transmission and reflection to a more neutral tone that is difficult to distinguish from ordinary uncoated glass.

Another issue is visible light transmission. Each infrared reflecting layer absorbs and reflects some visible light. Coating stack that are highly reflective in the infrared wavelength range tend to have visible light transmission that is too low for windshields and other positions requiring visible light transmission of at least 70%. Silver based coatings have achieved 70% visible light transmission by limiting the total combined thickness of the silver layers as well as the thickness of each silver layer. While this approach works, it is difficult to control and maintain consistent thickness in the angstrom tolerance range. As the number of silver containing layers is increased, the total layer thickness cannot substantially increase so each individual silver containing layer must be made that much thinner. Normal process variation can result in a coating that is out of specification for color, reflection or transmission.

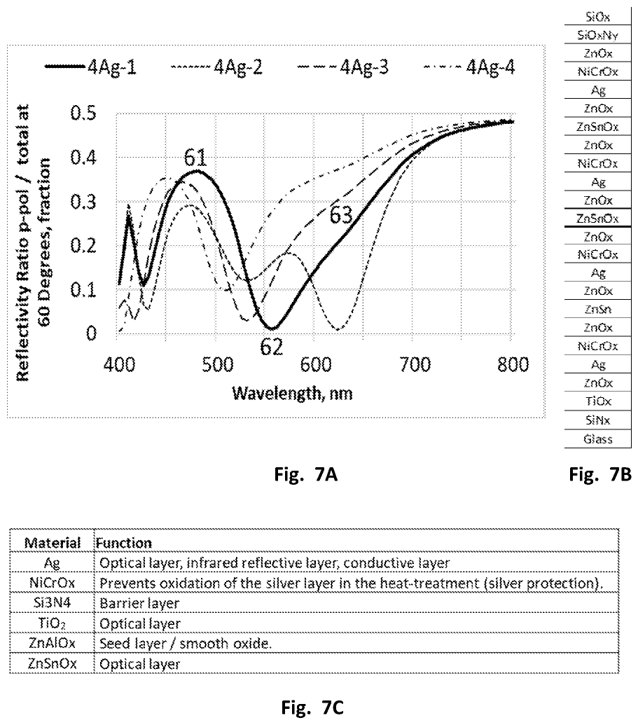

One exemplary embodiment of the coating stack is shown in FIG. 7B. FIG. 7C shows some of the typical materials used in the coating stack and their function. Note that many of the layers have more than one function. The selection of materials used, the sequence of the layers and the layer thicknesses have been carefully selected to optimize for: maximum reflection of p-polarized light, maximum transmission of visible light, maximum reflection of infrared light, neutral color, scratch resistance, heat resistance and low electrical conductivity.

While optimizing for just one of these variables can be challenging, optimizing for all and achieving the results exhibited in the charts of FIG. 7A is even more so. As a result of this careful selection and tuning it is possible to use thinner silver containing layers than has previously been possible or practical. The silver containing layer of this invention is a layer that comprises mostly silver and in small percentages may comprise other elements. Each of the four silver containing layers of the exemplary stack are at least 100Å in thickness with a total combined thickness of the four-silver layers of almost 470 Å. This allows for lower production costs by increasing throughput while reducing rejects. The other major benefit that comes from increasing the silver layer thickness is lower sheet resistance which makes it possible to use the coating to form a resistive heating element for a defroster circuit in the laminate which can operate in a standard 12 V automotive electrical system.

As can be appreciated, there are a near infinite number of permutations that can be made based upon the stack of FIG. 7B which shows just one possible embodiment. The various layers interact and work together as a system. A change to the thickness of one layer will shift the overall parameters of the coating stack. However, a change can then be made to one or more of the remaining layers to compensate and bring everything back to the baseline. Likewise, there are known materials which are equivalents which may be substituted in the stack to no detriment.

While the exemplary coating stack illustrated results in a neutral color in both reflection and transmission, very subtle variations in the layer thicknesses can be made which while retaining a neutral color in transmission can produce a reflection, when illuminated by p-polarized light, that is tuned to accentuate certain colors while attenuating others to improve the effectiveness of the HUD display. We can see this in the chart of FIG. 7A.

In FIG. 7A, the ratio of p-polarized to total reflectivity is shown for four, four silver containing layer coatings named 4Ag-1, 4Ag-2, 4Ag-3 and 4Ag-4 respectively. Coatings 4Ag-2, 4Ag-3 and 4Ag-4 are commercial coatings that are in production and available in the market. Coating 4Ag-1 is the coating stack of the invention. We note that the commercial coatings 4Ag-2, 4Ag-3 and 4Ag-4 all have a high reflectivity ratio in the 510590 nm wavelength range whereas coating 4Ag-1, approaches a minimum of near zero at the local extreme indicated as 62 while having two maxima at the local extrema indicated as 61 and 63 each having a reflectivity ratio in excess of 0.3 at other wavelength ranges: one in the 450-510 nm and one in the 590-670 nm.

The minimum reflectivity ratio for the coatings mentioned above is in the region where the human eye sensitivity is the highest. When projecting a preferential p-polarized image onto a glazing with the HUD coating described above the projected image will be less intense as a result. The contrast preference is given to the actual image (the road, traffic, pedestrians, etc.) and there is less distraction by the augmented information of the projected image.

This is complemented by the two maxima in the 450-510 nm and 590-670 nm regions, where the eye sensitivity is the lowest. The perceived image will be brighter or enhanced.

The response of this coating is radically different from the coatings of the prior art in this respect.

An embodiment of the coating stack is not shown but we can go in the opposite direction as well and produce a coating that will have a maximum in the 510-590 range and minima in the other two ranges 450-510 nm and 590-670 nm. The result will emphasize the portion of the image near the maximum in the 510-590 which may be desirable in some applications.

The peak sensitivity of the human eye changes by about 20 nm when the human eye is subjected to changes in the ambient light going from photopic (high intensity) to mesopic (lower intensity), to scotopic (very low intensity). The projector can be configured shifting the wavelengths comprising the image in the 450-510 nm and 590-670 nm in response to the ambient lighting conditions, changing the peak of the projected color distribution from 520 nm to 500 nm (450-510 nm) and from 640 nm to 620 nm (590-670 nm) to improve projected image visibility.

Al of the exemplary embodiments that follow comprise the coating of FIG. 7B. The coating is applied to the unbent flat glass by means of a large MSVD coater. To allow for the maximum thickness of silver and corresponding low resistivity and high solar reflectivity, the coating is applied to a clear glass substrate. A low-iron ultra-clear may be used for further enhancement. Likewise, the second glass layer is also formed from a clear or ultra-clear soda-lime glass.

Surface two of the outer glass layer is coated so as to maximize the solar performance. This also improves the defrost performance by placing the heating element closer to surface one which the outside surface of the glazing. The coating may also be applied to surface three but with slightly lower heating performance.

The outer glass is cut to shape, painted with a black obscuration, and fired prior to being coated. The coated outer and the inner glass layers are separately bent by means of a full surface press bending process. The two layers are assembled with a PVB interlayer and laminated.

The laminated windshield is installed in a vehicle and a HUD projector projecting mainly p-polarized light is mounted in the instrument panel such that the angle of incidence relative to the windshield is 60°. The projector shifts the wavelength of the image by 20 nm in response to changes in ambient lighting.

### Description of Embodiments

1. Embodiment one comprises a laminated automotive windshield with a 2.1 mm thick ultra-clear soda-lime inner and outer glass layer with a 0.76 mm thick PVB interlayer and a transparent HUD coating applied to the number two surface of the outer glass layer. The HUD coating stack comprises four silver containing layers. The chemical composition of each layer is shown in FIG. 7B. A HUD projector is mounted in the instrument panel and projects primarily p-polarized beams that are incident to the laminated automotive windshield at an angle of 60 °.
2. Embodiment two is the automotive laminate of embodiment one further comprising a set of busbars in contact with the HUD coating which when connected to a standard 12 V automotive system, with sufficient power, develops a power density of at least 4 watts per square decimeter.
3. Embodiment three is a modification of embodiment one wherein the HUD coating stack is modified such that the sheet resistance is 1 ohm per square, the color remains neutral in transmission and a 12% color enhanced visible reflection is produced by the coating at a 60° angle of incidence for p-polarized light.
4. Embodiment four is a modification of embodiment one wherein the HUD coating stack is modified such that the sheet resistance is 1 ohm per square, the color remains neutral in transmission and a 10.5% neutral visible reflection is produced by the coating at a 60° angle of incidence for p-polarized light.
5. Embodiment five is a modification of embodiment one wherein the HUD coating stack is modified such that the sheet resistance is 0.9 ohms per square, the color remains neutral in transmission and a 11% color enhanced reflection is produced by the coating at a 60° angle of incidence for p-polarized light.
6. Embodiment six is a modification of embodiment one wherein the HUD coating stack is modified such that the sheet resistance is 0.9 ohms per square, the color remains neutral in transmission and a 10.5% neutral visible reflection is produced by the coating at a 60° angle of incidence for p-polarized light.
7. Embodiment seven is a modification of embodiment one wherein the HUD coating stack is modified such that the sheet resistance is 0.8 ohms per square, the color remains neutral in transmission and a 9% color enhanced reflection is produced by the coating at a 60° angle of incidence for p-polarized light.
8. Embodiment eight is a modification of embodiment one wherein the HUD coating stack is modified such that the sheet resistance is 0.8 ohms per square, the color remains neutral in transmission and a 9% neutral visible reflection is produced by the coating at a 60° angle of incidence for p-polarized light.
9. Embodiments nine through sixteen are comprised of each of the previous embodiments, one through eight, further comprising a ZrSixNy optical/protective layer in the stack.
10. Embodiment seventeen is according to any one of the preceding embodiments wherein the HUD coating has a visible light transmission greater than 70%.
11. Embodiment eighteen is according to any one of the preceding embodiments wherein each one of the silver containing layers of the HUD coating has a thickness of at least 100 Å.
12. Embodiment nineteen is according to any one of the preceding embodiments wherein the laminated automotive glazing further comprises at least one additional HUD projector (multiple HUD projectors).
13. Embodiment twenty is according to any one of the preceding embodiments wherein the HUD coating has 3 local extrema in the ratio of p-polarized reflectivity to total reflectivity in the visible wavelength range of 450-670 nm, whereas the absolute value of the difference between the average of the two extrema of the same type and the opposite is greater than or equal to 0.3.
14. Embodiment twenty-one is according to any one of the preceding embodiments with the exception that the HUD coating stack is applied to the number three surface of the inner glass layer.
15. Embodiment twenty-two is according to any one of the preceding embodiments with the exception that the image formed by the projected beam of the HUD projector is comprised of mixed light polarization wherein the percentage of p-polarized light is at least 20%.
16. Embodiment twenty-three is according to any one of the preceding embodiments with the exception that the image formed by the projected beam of the HUD projector is comprised of mixed light polarization wherein the percentage of p-polarized light is at least 50%.
17. Embodiment twenty-four is according to any one of the preceding embodiments with the exception that the image formed by the projected beam of the HUD projector is comprised of mixed light polarization wherein the percentage of p-polarized light is at least 75%.
18. Embodiment twenty-five is according to any one of the preceding embodiments with the exception that the image formed by the projected beam of the HUD projector is comprised of mixed light polarization wherein the percentage of p-polarized light is at least 90%.

1. An automotive HUD system comprising:
an automotive laminate having:
at least two glass layers, inner and outer glass layers;
at least one plastic bonding layer; and
a transparent coating;
wherein:
said coating is applied to at least one of the interior surfaces of said laminate;
said coating is comprised of at least four silver inclusive layers; and
the value of the ratio of p-polarized reflectivity to total reflectivity of said coating takes on one local extreme in each of three spectral regions: 450-510 nm; 510-590 nm; and 590-670 nm;
wherein:
two of the three local extrema are of the same type with the remaining third local extrema being of the opposite type of the first two; and
the difference of the ratios between the average of the two local extrema of the same type and the opposite is greater than or equal to 0.3;
at least one HUD projector.

2. The automotive HUD system of claim one wherein the image formed by the projected beam of the HUD projector is comprised of mixed light polarization wherein the percentage of p-polarized light is at least 20%.

3. The automotive HUD system of any one of the preceding claims wherein the angle between the projected beam of said the HUD projector and the automotive laminate is substantially at the Brewster angle within ±10%.

4. The automotive HUD system of any one of the preceding claim wherein the coating has visible light transmission of greater than 70%.

5. The automotive HUD system of any one of the preceding claims wherein each silver containing layer of the coating has a thickness of at least 100 Å.

6. The automotive HUD system of any one of the preceding claims wherein the coating has a sheet resistance of no greater than 1.0 ohm per square.

7. The automotive HUD system of any one of the preceding claims wherein the local extrema of the ratio of p-polarized reflectivity to total reflectivity comprises two maxima and a minimum.

8. The automotive HUD system of any one of claims one to six wherein the local extrema of the ratio of p-polarized reflectivity to total reflectivity comprise two minima and a maximum.

9. The automotive HUD system of any one of the preceding claims wherein the coating further functions as a resistive heating element.

10. The automotive HUD system of claim nine wherein the resistive heating element is powered by a 12 V automotive electrical system.

11. The automotive HUD system of claims nine and ten wherein the average power density of the resistive heating element in the daylight opening is at least 4 watts per decimeter squared.

12. The automotive HUD system of any one of the preceding claims wherein the reflected color, when illuminated by the HUD projector at or near the Brewster angle, is color enhanced.

13. The automotive HUD system of any one of the preceding claims wherein the sheet resistance of the coating is less than or equal to 0.8 ohms per square.

14. The automotive HUD system of any one of the preceding claims wherein the sheet resistance of the coating is less than or equal to 0.6 ohms per square.

15. The automotive HUD system of any one of the preceding claims wherein the coating further comprises a ZrSixNy optical/protective layer.

16. The automotive HUD system of any one of the preceding claims wherein the inner glass layer is of a thickness that is less than 1.0 mm.

17. The automotive HUD system of any one of the preceding claims wherein the transmitted color of the coating is substantially neutral.

18. The automotive HUD system of any one of the preceding claims wherein the total solar energy rejected by the automotive laminate is at least 40%.

19. The automotive HUD system of any one of the preceding claims wherein the wavelength of the image of the HUD projector is shifted in response to ambient lighting conditions.

20. The automotive HUD system of any one of the preceding claims further comprises multiple HUD projectors.

21. An automotive laminate according to any one of the preceding claims.
